(19) United States
(12) Patent Application Publication
(10) Pub. No.: US 2004/0128665 A1
(43) Pub. Date: Jul. 1, 2004

(54) Method and system of conditional access to ip service

(76) Inventors: Emmanuel Gouleau, Chevaigne (FR); Noel Fontaine, Saint Gilles (FR); David Girault, St Jacques de La Lande (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/474,687

(22) PCT Filed: Apr. 18, 2002
(86) PCT No.: PCT/FR02/01337

(30) Foreign Application Priority Data
Apr. 19, 2001 (FR) 01 05318

(51) Int. Cl. G06F 9/44

(52) U.S. Cl. 717/171; 717/173; 717/176

(57) ABSTRACT

1. Method for transmitting information (20) with access control via a network (3) utilizing an IP type protocol.

According to the invention, at transmission:

scrambling a first datagram (23);

defining a header (24) comprising at least one datum identifying the access control means;

concatenating this header (24) with the first scrambled datagram (23) in order to create a data block (26);

encapsulating the data block (26) in a second IP datagram (30);

transmitting this second IP datagram (30) over the network;

at reception:

extracting the data block (26) from the datagram received;

extracting the header (24);

descrambling the first datagram (23) if access to this data is authorized;

delivering the descrambled data.

### TECHNICAL FIELD

The present invention is in the technical field of scrambling and access control to IP services.

The invention relates more particularly to a method and a system for transmitting/receiving information with access control over a network utilizing the IP protocol as well as a device making possible implementation of the method.

This method can be utilized for controlling access to services of audiovisual flow over IP and data distribution services distributed by satellite over the internet.

### PRIOR ART

A number of solutions are currently used for realizing scrambling and control of access to IP data. Of these solutions, we cite the IPSEC standard that makes it possible to transport in a confidential fashion data in IP datagrams point-to-point. This standard offers the following services:

confidentiality

authentication

integrity.

The IPSEC protection does not require modification of the server or the application software installed at the client location. However, scrambling is generally applied to the entirety of the traffic between the client and the server and not only to a specific service. Also, to the extent where the traffic comprises data that do not require protection, the IPSEC standard cannot be used if selective scrambling is to be done on defined services.

Another drawback of this standard is the fact that it imposes the existence of a return path. Now, in the framework of a point-multi-point application, the return path is not necessary; for example, transmission by satellite (multicast).

In addition, the exchange of the keys makes it possible to access the contents is done by means of utilization of public key algorithms. Because of this, this standard does not make it possible to determine access to the contents of the information in return for having rights such as those defined for digital television, for example (pay per view, subscription, etc.) and that are written to a safe processor.

We also cite the SSL (Secure Socket Layer) standard that is an encryption method applied to data at the level of the transport layer. This method utilizes protocol identifiers and port numbers for distinguishing the protected data from the unprotected data. For example, a hypertext link over the network will use this method if the protocol identifier indicates HTTPS instead of HTTP. The data protected by SSL navigate generally over a connection to port 443 of the TCP server. Also, if the server receives a connection to port 443, it applies the SSL scrambling to this connection and transmits the IP data to the client. This procedure makes it possible for the client and the server to distinguish the protected data from those that are not protected.

One drawback of this method resides in its dependence on the TCP transport protocol used and thus imposes formatting of data of this protocol on the data to be scrambled.

The object of the invention is to remedy these drawbacks of the prior art described above by means of a process making it possible to generically scramble IP services and to control access to these services by means of an access control device such as a chip card.

A further object of the invention is to remove the constraints connected with the transport protocol.

A further object of the invention is to provide scrambling of IP data regardless of the application using said data, especially in the following service configurations:

point-to-point services;

multi-point service with the existence of a client-server return path;

multi-point services without a client-server return path;

These objects are achieved by means of a method comprising the following steps:

At transmission:

scrambling a first IP datagram;

defining a header comprising at least one datum identifying the access control means;

concatenating this header with the first encrypted datagram in order to create a data block;

encapsulating the data block in a second IP datagram;

transmitting this second IP datagram over the network, and

at reception:

extracting the data block from the datagram received;

extracting the header;

descrambling the first datagram if access to the data is authorized;

delivering the descrambled data.

According to the invention, the data block is encapsulated in a UDP packet.

According to the invention, the data block is encapsulated directly in an IP datagram.

According to the invention, the scrambling step comprises the following phases:

defining the services to be encrypted by a label to which an IP source address corresponds or an destination IP address;

saving at least one access condition or at least a private key.

According to the invention the data block comprises:

the header (access_control_header) moving the information necessary to the processing by a user terminal of the data transported; and

a sequence (payload) representing the information to be scrambled.

According to the invention, the data block observes the following syntax:

| CAS_DATAUNIT( ){ | |
|---|---|
| Access_control-header( ) | p octets |
| Payload | q octets |
| } | |
| According to the invention, the sequence (payload) | |
| observes the following syntax: | |
| payload ( ) { | |
| data bytes | n octets |
| padding bytes | p octets |
| (p can assume the value 0) | |
| } | |

The header comprises in addition a field (EDC) representing a sequence of error detection.

According to one embodiment of the invention, in which the data block is inserted into a DDP packet, which is itself inserted into an IP datagram on transmission, a UDP source port is dynamically allocated to the opening of the UDP link.

In this embodiment, the attribution of the UPF destination port number can be done statically (configuration data eventually dedicated by a regulatory authority) or even dynamically by a signaling protocol between the scrambler and the descrambler.

According to this embodiment of the invention, reception of the IP/UDP datagrams by the final client comprises the following steps:

receiving the second IP datagram;

receiving the UDP packet via the port, previously opened (static or dynamic port);

recovering and descrambling the data block;

extracting the header;

sending the descrambled IP datagram on a pseudo-driver;

extracting the data from the first destination datagram;

sending the extracted packet to the destination. application.

According to an alternative in this embodiment, reception of the UDP datagrams by the final client comprises the following steps:

receiving the second IP datagram;

receiving the UDP packet over the open port (static or dynamic port);

recovering and descrambling the data block;

extracting the header;

re-transmitting the first IP datagram over the loopback address of the IP stack;

extracting the data of the first datagram and sending them to the destination application.

According to the invention, the IP services transmitted are audiovisual flux over IP.

According to the invention, the IP services transmitted are data transmitted by satellite via an IP network.

The data are transmitted over an IP network by a transmitter comprising means for associating a header with the IP, said header comprising at least one datum identifying the access control means and an indication of the scrambling method used.

The transmitter according to the invention comprises in addition:

means for defining the services to be encrypted by a label to which an IP source address corresponds or an IP destination address;

means for capturing at least one access condition or at least one private key.

According to the invention, this transmitter comprises an IP data flux server, a gateway comprising an IP encrypter, an ECM generator, an EMM generator and a database.

Reception of the data transmitted over the network is realized by a receiver comprising means for extracting the header of an encrypted datagram and means for activating at least one access condition or at least one private key.

The scrambling system and the access control in an IP type network comprises a transmitter and a receiver as described above.

The scrambling device and the IP services access control according to the invention comprises a human-machine interface intended to define the scrambling services and capturing conditions of access or private keys.

According to the invention, the access control means comprising a chip card for the transport of the private key.

### BRIEF DESCRIPTION OF THE FIGURES

Other features and advantages of the invention will become apparent from the following description, provided as a non-limiting example, with reference to the appended figures, wherein:

FIG. 1 diagrammatically represents a data transmission/reception system with access control according to the invention;

FIG. 2 diagrammatically represents the steps for defining the structure of a datagram according to the invention;

FIG. 3 diagrammatically represents a preferred embodiment of scrambling according to the invention;

FIG. 4 diagrammatically represents a first receiving mode implemented in the method according to the invention;

FIG. 5 diagrammatically represents a second receiving mode implemented in the method according to the invention;

FIG. 6 diagrammatically represents a data scrambling system in a point-to-point environment according to the invention.

### DETAILED DESCRIPTION OF THE EMBODIMENTS OF THE INVENTION

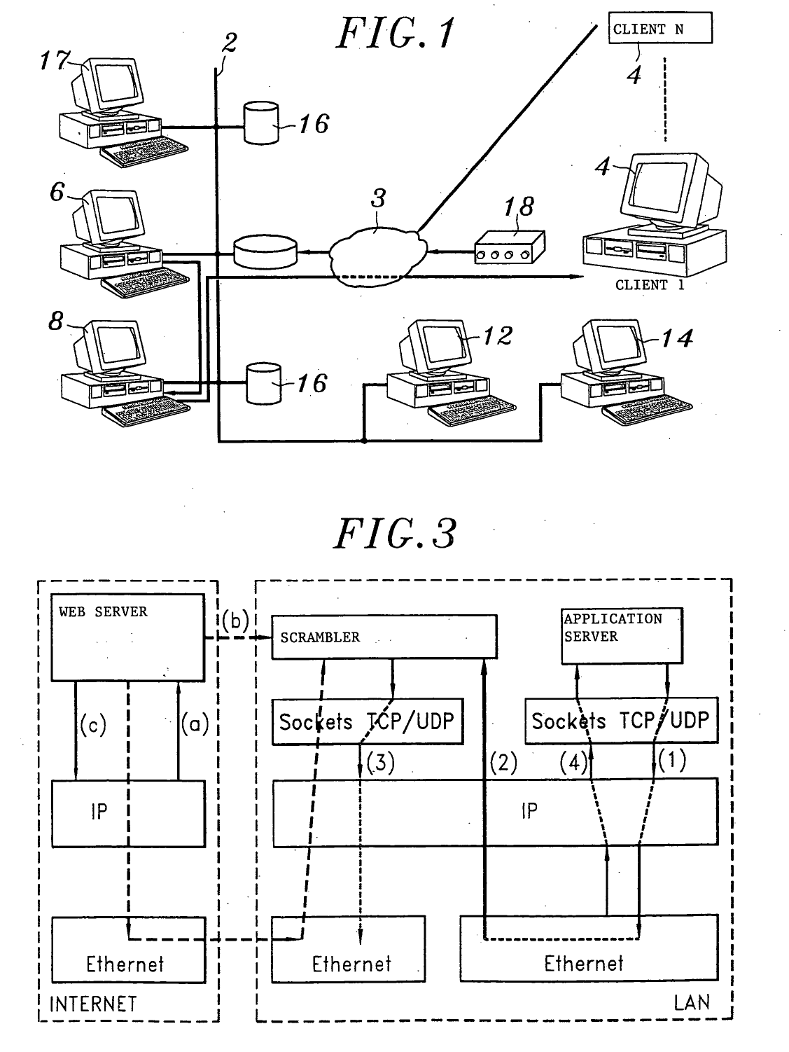

FIG. 1 diagrammatically represents a system in which several data processing and transmitting devices are interconnected in a local network 2 (LAN, local area network) that is connected, via the internet network 3, to a plurality of clients 4. The LAN 2 comprises an IP data flow server 6, a gateway 8 comprising an IP scrambler, an ECM generator 12 (access control message DVIB, entitlement control message), an EMM generator 14 (access management message DVB, entitlement management message) and a database 16. The LAN 2 is connected to a web server 17. The web server 17 indicating the characteristics of the server application (@IP_server, name_program, scrambling_active) is not necessarily on the same LAN 2.

The IP data delivered by the flow server 6 can be audiovisual services requiring the possession of an access right registered on a chip card held by the entitled clients 4. These audiovisual services are scrambled by the IP scrambler integrated n the gateway 8 before being transmitted over the internet network 3.

Each client 4 has equipment 18 comprising an access control device such as, for example, a chip card.

The gateway 8 is endowed with a human-machine interface HMI program enabling it:

to define the services to scramble;

to capture the access conditions or the private keys.

The services to be scrambled are identified by a label, a source IP address or an IP destination address corresponding thereto according to which one wants to scramble the data from a source and/or going to a destination.

As is represented by the tables below (Table I and II), scrambling of the data results in coupling the identifier of the service (IDservice), characterized by the source (s) and/or destination address (d) of the IP datagrams and an scrambling key. The periodicity of renewal of this key is relatively low in the systems not utilizing the chip card (Table I) and can be higher in the systems using a card (Table II). In these latter it carries the name of the control word.

TABLE I

| | Address to | Origin | |
|---|---|---|---|
| | filter and | (source or | Scrambling |
| ID Service | scramble | destination) | Key |
| Service p | @ format IPVX | S and/or D | |

TABLE I

| | Address to | Origin | | |
|---|---|---|---|---|
| | filter and | (source or | | Access |
| Label | scramble | destination) | Control Word | Conditions |
| Service j | @ in format | S and/or D | | CA i |
| | IP VX | | | |

In the systems using a chip card, obtaining a control word is subject to the possession of rights previously registered on the card.

The signaling linked to the implementation of the access control system utilizing the chip card for restoring the control words in the IP context covers in order of priority the following services:

data distribution services utilizing the UDP/IP stack: IPSat (push, file transfer);

audiovisual distribution services over IP (IP multi-point flow) utilizing the UDP/IP stack (multi-point videoconference or audioconference, audiovisual distribution);

audiovisual consultation services over IP utilizing the UDP/IP stack (VOD, videoconference point-to-point, telephony over IP);

transactional services utilizing the TCP/IP stack.

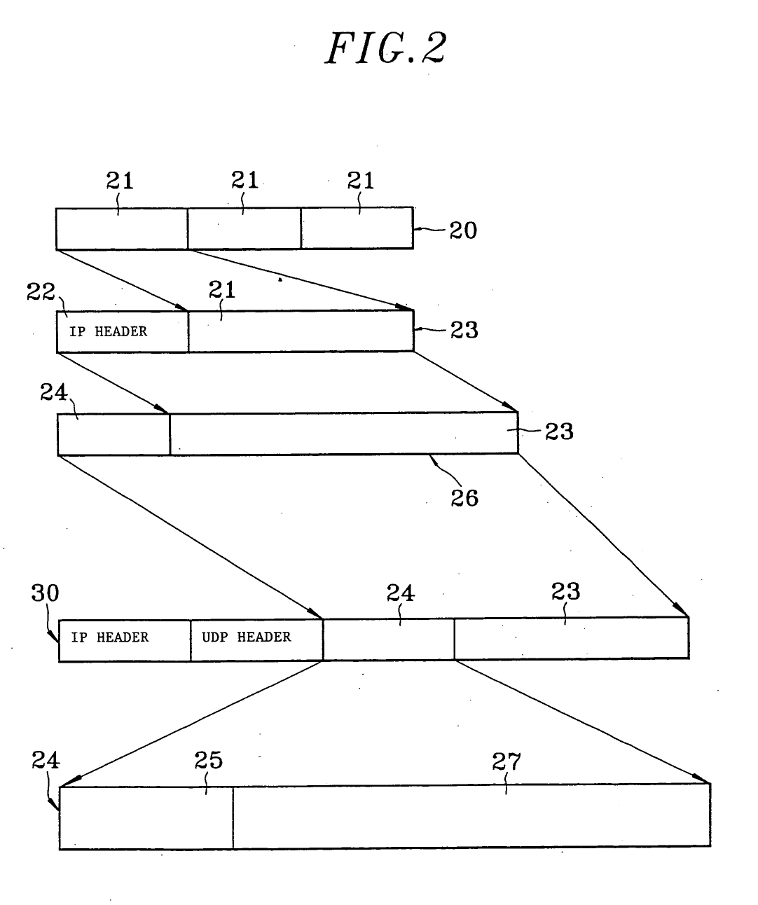

FIG. 2 diagrammatically represents the steps for creating a datagram according to the invention. The data to be transmitted 20 are initially cut up into packets 21 that can be of variable lengths. Each packet 21 is then associated with an IP header 22 to constitute a first IP datagram 23.

The transmission of the packets 21 over the IP network is based on the following principle:

scrambling of the first IP datagram 23 (PDU, protocol data unit);

definition of a header 24 “access_control_header” known as access control signal making it possible to provide to the descrambler the elements occurring in the scrambling operation. This header 24 comprises a discriminator 25 identifying the type of access control system used for scrambling the IP datagram 23 and the control data 27.

concatenation of this header 24 and the IP datagram 23 to form a data block 26;

encapsulating this data block 26 in an UDP datagram.

The set of these operations is called IP-CAS (IP conditional access system) in the following description.

The general structure of a header 24 is illustrated in Appendix 1 describing the different fields representing the binary data blocks. This header 24 comprises:

a field (header_length) representing the total length of the header 24;

a field (payload_scrambling_control) indicating the mode of application of the scrambling in the case of scrambling of useful information.

The header 24 can also comprise a field (EDC) representing an error detection sequence. According to the invention, if (payload_scrambling_control≠00), the header 24 (access_control_header) comprises in addition a field (payload_descrambling_way) stating the mode of descrambling of the content of the payload.

If the field (payload_descrambling_way=xi), xi being a binary value, the header 24 comprises in addition a field (ECM_CA_descriptor_flag) indicating the presence of at least one conditional access descriptor (ECM_CA_descriptor) in the header 24 of the scrambled datagram 23, and a field (ECM_flag) indicating, when its value is equal to 1, the presence of at least one field ECM( ) in the header of the scrambled datagram 23.

If (ECM_CA_descriptor_flag≠1), the header 24 comprises a field (Nb_ECM_CA_descriptor) indicating the number of blocks (ECM_CA_descriptor) present in this header 24 of the scrambled datagram 23.

The header 24 also comprises a field (access_control_header_start_sequence) or making it possible to identify the start of the header, a field (version_number)•indicating the current version of the header 24, a field (service_ID) indicating the reference of the service utilized, a field (payload_type) indicating the type of data transmitted, and a field (RUF0) reserved for future use.

The header 24 comprises in addition a field (scrambling_algorithm_type) for indicating the type of algorithm used for scrambling the datagram and an error correction field (CRC_32) for the descrambled useful data.

If the datagram 23 is scrambled using an algorithm functioning in the block mode, the header 24 (access_control_header) comprises in addition:

a field (payload_padding_size) stating the number of filler bytes added at the end of the payload;

a field (IVOperator_ID_length) indicating, when its value is different from zero, the presence and the length of the initialization vector field of the scrambler;

a field (IVOperator_ID_value) indicting, when the value of (IVOperator_ID_length) is different from zero, the value of the scrambler initialization vector, and

a field (RUF1) reserved for future use.

The header 24 comprises in addition a field (ECM_CA_descriptor_flag) indicating, when its value is equal to 1, the presence of at least one conditional access descriptor (ECM_CA_descriptor) in the header 24 of the scrambled datagram 23, a field (RUF2) reserved for future use.

The header 24 also comprises a field (ECM_CA_descriptor_version_number) indicating the version of the block (ECM_CA_descriptor).

If (EMM_CA_descriptor_flag=1), the header 24 comprises a field (EMM_CA_descriptor) indicating the version of the block (EMM_CA_descriptor) and a data block (EMM_CA descriptor).

If (ECM_flag=1), the header 24 comprises a field (NB_ECM) indicating the number of ECM in the header 24 of the scrambled datagram 23.

If (payload_descrambling_way≠010), the header 24 comprises a third field (RUF3) reserved for future use.

The access control message comprises:

an ECM_index pointer for differentiating a plurality of ECM for selecting a particular ECM for descrambling;

an ECM_table table containing the data of the ECM and the phase changing instructions.

By way of example, the access control message has the following format:

| | |
|---|---|
| ECM( ) { | |
| ECM_index | 8 bits |
| ECM_table( ) | 8 bits |
| } | |

where ECM_index represents the ECM associated with the descriptor of conditional access, and

ECM_table( ), represents the structure of the ECM.

The ECM table comprises:

an identification field (table_id)

a field indicating the length of an ECM, (ECM-length)

ECM_table( ), has the following structure:

| | |
|---|---|
| ECM_table( ){ | |
| table_id = 0x0 or 0x81 | 8 bits |
| NOT_USED | 4 bits |
| ECM_length | 12 bits |
| NOT_USED | 8 bits |
| For (i = 0; i < N; i++)( | |
| ECM_data_bytes | 8 bits |
| ) | |

wherein,

table_id represents an 8 bit field that identifies the type of data contained in the table;

a field (descriptor_tag) indicting the start of a conditional access descriptor ECM;

a field (ECM_CA descriptor_length) indicating the length of an ECM descriptor;

a field (CA_system_ID) representing an identifier of the access control system utilized;

a pointer (ECM_index).

By way of example, the conditional access descriptor (ECM_CA_descriptor) has the following format:

| | |
|---|---|
| ECM_CA_descriptor( ){ | |
| Descriptor_tag = 0x09 | 8 bits |
| ECM_CA_descriptor_length | 8 bits |
| CA_system_ID | 16 bits |
| ECM_index | 8 bits |
| for (i = 0; i < N; i++){ | |
| private_data_bytes | 8 bits |
| } | |

and the algorithm type identifier comprises:

a CI_tag identifier;

a CI-length field indicating the length of the identifier;

a CI_value field indicating the value of the CI-tag identifier.

The identifier of the type of scrambling algorithm has the following format:

| | |
|---|---|
| CI ( ) { | |
| CI_tag = 0x13 | 8 bits |
| CI_length = 0x01 | 8 bits |
| CI_value | 8 bits |
| } | |

The service operator comprises:

a SOID_tag identifier of the block making it possible to describe the zone of the service operator utilized in the chip card;

a SOID_length field indicating the length of said zone;

a SOID_value field indicating the value of the SOID_tag identifier.

The service operator is identified by a field presenting the following syntax:

| | |
|---|---|
| SOID( ) { | |
| SOID_tag = 0x14 | 8 bits |
| SOID_length = 0x03 | 8 bits |
| SOID_value | 24 bits |
| } | |

where

SOID_value represents a field identifying a service zone utilized in the chip card.

Two scrambling options are proposed:

systematic scrambling of the descending flow;

scrambling activated by the web-server 17.

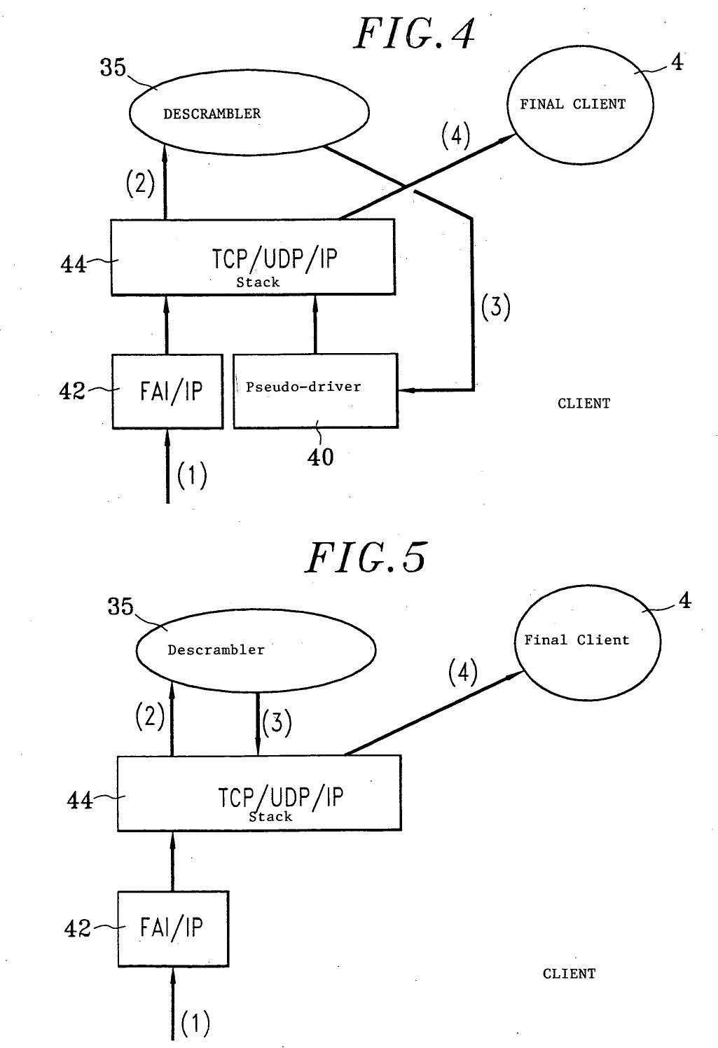

FIG. 4 diagrammatically represents the scrambling activated by the web server 17 (step (c)) on the initiative of the client (step (a)). In this case, an active demon on the web server 17 sends an activation request to the IP scrambler (step (b)) on receiving an HTTP request (a) of the client on a link with the “activate scrambling” parameter (key word in the URL http://@IP:port/prog_scrambled/name_program).

The scrambling scenario is as follows:

1) The flow server 6 sends IP datagrams 23 in point-to-point or in multi-point mode. The destination address of the datagrams 23 is that of the client (point-to-point) or even a distribution address (multi-point).

2) The IP scrambler filter eventually the datagrams IP 23, whose original address is that of the flow server 6 and maintains a scrambling session by address of destination. This filter acts at the Ethernet level in the drawing of FIG. 4.

3) The IP scrambler then concatenates the header 24 (access_control_header) to the IP datagram 23 that is scrambled at step 2, then send this field over a UDP stack via the same destination address as that of the initial datagram.

4) The destination datagrams of the flow server 6 are not intercepted by the IP scrambler.

In order to realize this scrambling procedure, the equipment doing the scrambling should identify the scrambling parameters. Several options are thus possible:

“cabled” information in a table on the IP scrambler;

interrogation by the IP scrambler of the dedicated web server 17 centralizing the necessary information;

updating of the IP scrambler by the web server 17;

local updating of the scrambler, done by the user.

The evaluation of the UDP/IP tunnel fields on transmission is done according to the following mechanism:

the scrambler generates an IP datagram with the following information:

the source IP address is the IP address of the scrambler. This address is a public IP address.

the destination IP address is the address of the destination of the initial datagram.

the UDP source port is dynamically allocated to the opening of the UDP stack.

The scrambled UDP flow port is not the same as the original UDP flux port in order to prevent looping problems on the client station. Two possibilities exist for assignment of the destination UDP port number called in the following UDP IP-CAS port:

dynamic attribution by a signaling protocol between the scrambler and the descrambler. This assumes the existence of a return path between the client and the server;

configuration value dedicated by a certification authority given using the following rules:

the known ports are the ports from 0 and 1023;

the registered ports are those from 1024 to 49151;

the ports dynamically assigned are those from 49152 to 65535.

Procedures on Reception: IP-CAS Virtual Stack

A “descrambling” software 35 is installed on the client station (Windows, Linux, MacOS, etc.). Two uses are envisaged: either the utilization of a pseudo-driver 40 or the utilization of the loopback in “raw” mode.

1—Utilization of a Pseudo-Driver

FIG. 5 represents this mode of use. The data are received on the interface of the access provider 42 on of the internet network 3 (FAI) and migrated via the IP stack 44 of the client machine to the descrambler 35 awaiting UDP data on the specific IP_CAS port. This descrambler 35 recoups the data of the UDP datagram via the IP stack, extracts the header <discriminator—access_control_header> and descrambles the origin IP datagram.

The descrambler 35 provides the IP datagram to the final client 4 awaiting data over the original destination port.

In order to transmit this IP datagram to the final client (local to the machine), the pseudo-driver network 40 must be developed under the IP stack:

This pseudo-driver is expecting data from the descrambler 35 and provides them to the IP stack.

The final application is awaiting on its particular port and recoups normally the data in plain text after de-encapsulation of the origin IP datagram by the IP/TCPouUDP stack.

This solution can be implemented on an operating system making it possible to ad a 2^{nd} network driver under the IP stack of the machine. The routing of the FAI drivers 42 and pseudo-driver 40 at the level of the IP layer is done on an IP address proper to each network driver according to the following mechanism:

(1) arrival of the UDP packet on the IP_CAS port,

(2) recuperation of the scrambled IP datagram 23,

(3) passage of the original descrambled IP datagram to the pseudo-driver,

(4) recuperation of the data on the destination port by the client 4.

This mechanism makes it possible to recuperate the original datagram 23 without modification, rendering the function of descrambling completely independent of the final client. It utilizes only the IP stack in UDP/TCP mode on reception of the data.

2—Utilization of the RAW Mode of the Loopback

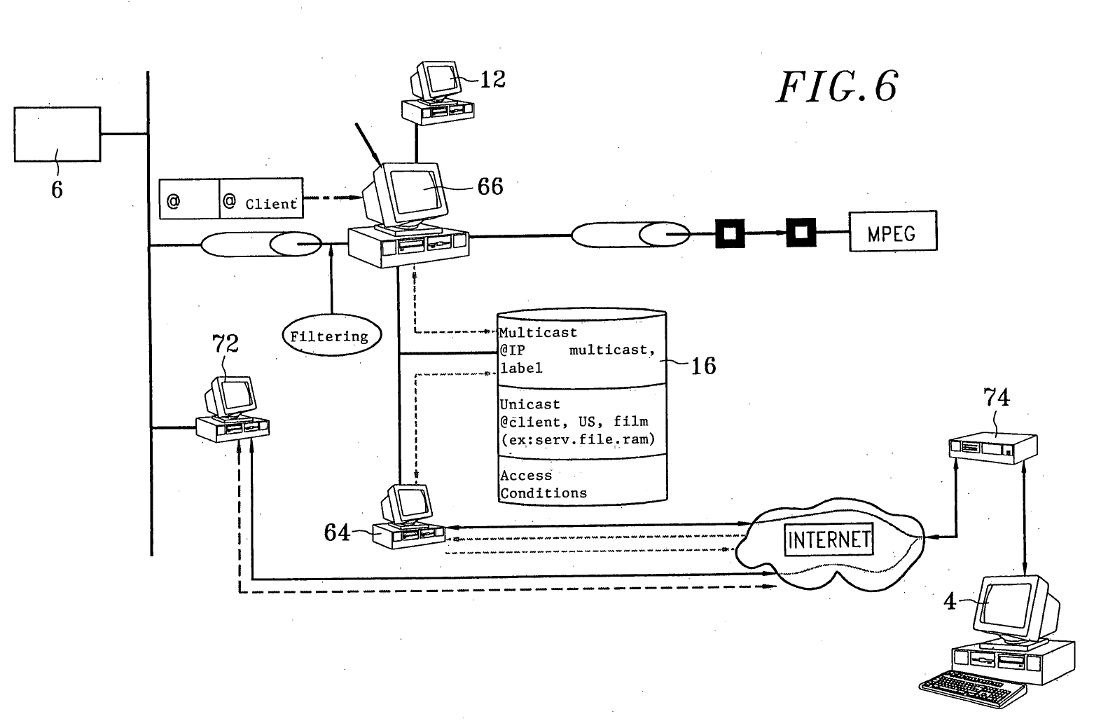

As is shown in FIG. 6, the data are received via the FAI interface 42 and migrated via the IP stack 44 of the client machine to the descrambler 35 awaiting the UDP data on the specific IP_CAS port. The descrambler 35 recuperates the data of the UDP datagram via the IP stack 44, extracts the header 24 <discriminator—access_control_header> and descrambles the original IP datagram 23. The descrambler 35 provides this IP datagram 23 to the final client awaiting data on the original destination port on UDP or TCP.

The IP datagram 23 is re-transmitted in the FAI/IP stack 42 via the IP stack 44 by passing the IP loopback to destination IP address of the machine (127.0.0.0). This re-transmission is done in RAW mode because the re-transmitted data constitute a complete IP frame that should not be modified. The loopback mechanism of the IP stack 44 retraces the data without re-transmitting them. The descrambler 35 is pending on its particular port and recovers the data in plain text normally after de-encapsulation of the IP datagram by the IP/TCP/UDP stack.

This solution can be implemented on an operating system making possible utilization of RAW mode of the IP stack 44 in loopback on the transmitter side and is done according to the following mechanism:

(1) arrival of the UDP packet via the IP_CAS port,

(2) recovery of the scrambled IP datagram,

(3) passage of the original descrambled IP datagram (with the destination IP address replaced by 127.0.0.0) on the pseudo-driver in RAW mode and loopback,

(4) recovery of the data on the destination port by the final client 4.

On the client side, this mechanism uses only the IP stack 44 in UDP/TCP mode on receiving the data in order to pass them to the descrambler 35 as on transmission of the data for re-transmitting them to the final application.

FIG. 7 diagrammatically represents a data scrambling system in a point-to-point environment according to the invention.

This system comprises a user terminal 4, a service provider 6, an ECM generator 12, a database 16, an offer presentation server 64, an access conditions editor 66, a RTSP type audiovisual command gateway 72, an internet access provider 74.

The following steps describe a user's access to a VOD service by using a chip card. The principle can be extended to other types of point-to-point services.

Access starts with a subscriber authentication phase. This phase starts just after the subscriber connects to the internet access provider 74.

During this session, the remote user terminal 4, his IP address, dynamically actuated by the access provider 74 at the time of connection to the network and the UA (unique address) of the card.

Phase 1: Presentation of the Officer

The user makes a HTTP request on an offer presentation server 64. The user terminal 4 receives a page presenting the services offering in terms of acquisition of right and in terms of content.

Presentation of the page is optional and can be managed directly by the operator. The page then appears only on demand by the subscriber, at the time of reloading rights, for example.

Phase 2: Program Selection

Phase 2 presupposes that the user has selected a particular service (for example, selection of a film on a VoD service).

Two actions unfold in parallel:

The first at the navigator's destination: phase 2;

The second at the scrambling system destination; phase 2′.

In this second phase, the presentation server re-transmits the entire URL of the film to the terminal in the HTTP response (for example: http://serv1.name-of-the-film.ram);

Phase 3: Launching the Execution Program of the Film Player

The user's navigator activates this program (in the present example, RealPlayer) by passing it in the film parameter “name_of_the_film.ram”.

The player is connected to the URL http://serv1/name-of-the-film.ram. An RTSP (start, stop, play, rewind, forward, etc.) command session is then opened between the terminal 4 and the command gateway 72, redirecting the RSTP request to the most appropriate flow server, the command gateway 72 and the flow server 6 are eventually combined.

Phase 4: Flow Server Connection

The RTSP server then opens a TCP session with the concerned server by delivering the film (here: serv1 . . . ).

Phase 5: Launching of the Broadcast

The flow server 6 then transmits the film in the UDP/IP datagrams to the scrambling gateway with the address of the server as the source address and the address of the final client as the destination address.

Phase 6: Scrambling of the Program

The scrambling gateway, whose point-to-point filters are activated automatically at the time of detecting the point-to-point services in the base 16, it can then generically (via @origin) or personally (via @addressee) or according to the URL the downcoming data.

Phase 7: The Closing of a Point-to-Point System

A point-to-point session can be closed by the scrambling session on time-out (non-receipt of packets from a source address or addressee data for X seconds). The maximum value of the point-to-point time-out is stated at the time of configuring the general parameters of the equipment.

APPENDIX

| | | |
|---|---|---|
| access_control_header( ){ | | |
| access_control_header_start_sequence | 32 | bits |
| header_length | 16 | bits |
| version_number | 8 | bits |
| service_ID | 16 | bits |
| payload_type | 8 | bits |
| payload_scrambling_control | 2 | bits |
| RUF 0 | 6 | bits |
| if (payload_scrambling_control !=00){ | | |
| scrambling_algorithm_type | 3 | bits |
| payload_padding_size | 8 | bits |
| payload-descrambling_way | 3 | bits |
| clear_payload_CRC32 | 32 | bits |
| IVoperator_ID_length | 8 | bits |
| IVoperator_ID_value IVoperator_ID_length* | 8 | bits |
| RUF 1 | 2 | bits |
| if(payload_descrambling_way==001){ | | |
| ECM_CA_descriptor_flag | 1 | bit |
| EMM_CA_descriptor_flag | 1 | bit |
| ECM_flag | 1 | bit |
| RUF 2 | 5 | bits |
| if (ECM_CA_descriptor_flag==1){ | | |
| Nb_ECM_CA_descriptor | 8 | bits |
| ECM_CA_descriptor_version_number | 8 | bits |
| for (i=0;i<n;i++){ | | |
| ECM_CA_descriptor( ) | | |
| } | | |
| } | | |
| if (ECM_CA_descriptor_flag==1){ | 8 | bits |
| EMM_CA_descriptor_version_number | | |
| EMM_CA_descriptor( ) | | |
| } | | |
| if (ECM_flag==1){ | | |
| NB_ECM | 8 | bits |
| for (i=0;i;i++){ | | |
| ECM( ) | | |
| } | | |
| } | | |
| } | | |
| if (payload_descrambling_way==010){ | | |
| RUF 3 | 16 | bits |
| } | | |
| } | | |
| EDC | 8 | bits |
| } | | |

1. A method for transmitting information (20) with access control over a network (3) using an IP type protocol, characterized in that it comprises the following steps:
On transmission:
scrambling a first datagram (23);
defining a header (24) comprising at least one datum identifying the access control means;
concatenating this header (24) with the first scrambled datagram (23) in order to create a data block (26);
encapsulating the data block (26) in a second IP datagram (30);
transmitting this second IP datagram (30) over the network, and
at reception:
extracting the data block from the datagram received;
extracting the header (24);
descrambling the first datagram (23) if access to this data is authorized;
delivering the descrambled data.

2. The method according to claim 1, characterized in that the data block (26) is encapsulated in a UDP packet.

3. The method according to claim 1, characterized in that the data block (26) is encapsulated directly in an IP datagram.

4. The method according to one of claims 1 to 3, characterized in that the scrambling step comprises the following phases:
defining the services to be scrambled using a label to which an IP source address or an IP destination address corresponds;
capturing at least one access condition or at least one private key.

5. The method according to claim 1, characterized in that the data block (26) comprises:
the header (24) (access_control_header) moving the information necessary for processing of the transmitted data by a terminal (4);
a sequence (payload) representing the useful data (20) to be scrambled.

6. The method according to one of the above claims, characterized in that the data block (26) observes the following syntax:

| | |
|---|---|
| CAS_data_unit( ) { | |
| Access_control_header( ) | p octets |
| Payload | q octets |
| }. | |

7. The method according to claim 5, characterized in that the sequence (payload) observes the following syntax:

| | |
|---|---|
| payload ( ) { | |
| data bytes | n octets |
| padding bytes | p octets (p can assume the |
| value 0) | |
| }. | |

8. The method according to claim 5, characterized in that the header (24) comprises:
a first field (header_length) representing the total length of this header (24);
a second field (payload_scrambling control) indicating the mode of application of the scrambling of the information (20).

9. The method according to claim 8, characterized in that the header (24) comprises in addition a field (EDC) representing an error detection sequence.

10. The method according to claim 8, characterized in that, if (payload_scrambling_control≠00), the header (24) comprises in addition a (payload_descrambling_way) field indicating the mode of descrambling of the information (20).

11. The method according to claim 10, characterized in that if (payload_descrambling_way=001), the header (24) comprises in addition a field (ECM_CA_descriptor_flag) indicating the presence of at least one conditional access descriptor (ECM_CA_descriptor) in the header (24) and a field (ECM_flag) indicating, when its value is equal to 1, the presence of at least one ECM( ) field representing an access control message in the header (24).

12. The method according to claim 11, characterized in that if (ECM_CA_descriptor_flag=1), the header (24) comprises in addition a field (Nb_ECM_CA_descriptor) indicating the number of blocks (ECM_CA_descriptor) present in this header (24).

13. The method according to claim 8, characterized in that the header (24) comprises in addition a field (access_control_header_start_sequence) making it possible to identify the start of the header (24), a field (version_number) indicating the current version of the header (24), a field (service_ID) indicating the reference of the service used, a binary field (payload_type) indicating the type of data transmitted, and a field (RUF0) reserved for future use.

14. The method according to claim 10, characterized in that the header (24) comprises in addition a field (scrambling_algorithm_type) for indicating the type of algorithm used for scrambling the datagram (23) and an error corrector field (CRC_32) of the descrambled useful data.

15. The method according to claim 14, characterized in that if the datagram (23) is scrambled using an algorithm functioning in block mode, the header (24) comprising in addition:
a field (payload padding_size) stating the number of padding octets added at the end of the information (20);
a field (IVOperator_ID_length) indicating, when its value is different from zero, the presence and the length of an initialization vector field of the scrambler;
a field (IVOperator_ID_value) indicating, when the value of (IVOperator_ID_length) is different from zero, the value of the initialization vector field of the scrambler, and
a field (RUF1) reserved for future use.

16. The method according to claim 11, characterized in that the header (24) comprises in addition a field (EMM_CA_descriptor_flag) indicating, when its value is equal to 1, the presence of at least a conditional access descriptor (ECM_CA_descriptor) in the header of the scrambled datagram (23), a field (RUF2) reserved for future use.

17. The method according to claim 12, characterized in that the header (24) comprises in addition a field (ECM_CA_descriptor_version_number) indicating the version according to the block (ECM_CA_descriptor).

18. The method according to claim 16, characterized in that, if (EMM_CA_descriptor_flag=1), the header (24) comprises in addition a field (EMM_CA_descriptor_version_number) indicating the following version of the block (EMM_CA_descriptor).

19. The method according to claim 11, characterized in that, if (ECM_flag=1), the header (24) comprises in addition a field (NB_ECM) indicating the number of ECM in the header (24) of the scrambled datagram.

20. The method according to claim 10, characterized in that, if (payload_descrambling_way=010), the header (24) comprises a field (RUF3) reserved for a future use.

21. The method according to claim 11, characterized in that the access control message comprises:
a pointer (ECM_index) for differentiating a plurality of ECM for selecting a particular ECM for descrambling;
a table (ECM_table) containing the data of the ECM and the phase changing instructions.

22. The method according to claim 21, characterized in that the table (ECM_table) comprises:
an identification field (table_id);
a field indicating the length of an ECM (ECM_length).

23. The method according to claim 17, characterized in that the conditional access descriptor (ECM_CA_descriptor) comprises:
a field (descriptor_tag) indicating the start of a conditional access descriptor ECM;
a field (ECM_CA_descriptor_length) indicating the length;
a field (CA_system_ID) representing an identifier of the system of access control used;
a pointer (ECM_index).

24. The method according to claim 14, characterized in that the identifier of the type of encrypting algorithm comprises:
an identifier (CI_tag);
a field (CI_length) indicating the length of the identifier (CI_tag);
a field (CI_value) indicating the value of the identifier (CI-tag).

25. The method according to one of the above claims, characterized in that the service operator is identified by a field comprising:
an identifier (SOID_tag) of the block making it possible to describe the zone of the service operator used in the chip card;
a field (SOID_length) indicating the length of said zone;
a field (SOID_value) indicating the value of the identifier (SOID_tag).

26. The method according to claim 2, characterized in that an UDP source port is dynamically allocated to opening the UDP link.

27. The method according to claim 2, characterized in that the attribution of the UDP destination port number is done dynamically using a signaling protocol between the scrambler and the descrambler.

28. The method according to claim 2, characterized in that the UDP destination port number is a value assigned by a certification authority.

29. The method according to claims 27 and 28, characterized in that the receipt of the IP/UDP datagrams by the final client comprises the following steps:
receiving the second IP datagram (30);
receiving the UDP packet via the static or dynamic UDP port previously opened;
recovering and descrambling the data block (26);
extracting the header (24);
sending the first descrambled IP datagram (23) to a pseudo-driver;
extracting the data from the first datagram (23);
sending the extracted packet to the destination application.

30. The method according to claim 28, characterized in that the receiving of the UDP datagrams by the final client comprises the following steps:
receiving the second IP datagram (30);
receiving the UDP packet on the static or dynamic port previously opened;
recovering and descrambling the data block (26);
extracting the header (24);
re-transmitting the first IP datagram (26) over the loopback address of the stack;
extracting the data from the first datagram (23) in order to send them to the destination application.

31. The method according to one of claims 1 to 30, characterized in that the IP services transmitted are audiovisual flows over IP.

32. The method according to one of claims 1 to 30, characterized in that the IP services transmitted are data transmitted by satellite over the IP network.

33. A transmitter for scrambled data over an IP type network capable of using the method according to one of claims 1 to 32.

34. The transmitter according to claim 33, characterized in that it comprises means for associating the IP datagrams (23) with a header (24) comprising at least one datum identifying the access control means and an indication of the scrambling method used.

35. The transmitter according to claim 34, characterized in that it comprises in addition means for defining the services to be scrambled using a label to which a source IP address or a destination Ip address corresponds;
means for capturing at least one access condition or at least one private key.

36. The transmitter according to claim 35, characterized in that it comprises an IP data flow server (6), a gateway (8) comprising an IP scrambler, an ECM generator (12), an EMM generator (14) and a database (16).

37. A receiver capable of receiving scrambled data according to claims 1 to 32.

38. The receiver according to claim 37, characterized in that it comprises means for extracting the header (24) of a scrambled block of data (26) and means for activating at least one access condition or at least one private key.

39. A scrambling and access control system in an IP type network, characterized in that it comprises a transmitter according to claim 33 and a receiver according to claim 37.

40. A scrambling and access control device for IP services comprising a transmitter according to claim 36, characterized in that it comprises in addition a human-machine interface for defining the services to be scrambled and for capturing at least one access condition or one private key.

41. The device according to claim 40, characterized in that the access control means comprise a memory card for transmitting the private key.
